(19) United States
(12) Patent Application Publication
(10) Pub. No.: US 2004/0026405 A1
(43) Pub. Date: Feb. 12, 2004

(54) Warming fabric with multiplex controller

(75) Inventors: Armando Alvite, Miami Lakes, FL (US); Leonard I. Horey, Boca Raton, FL (US)

Correspondence Address: LEYDIG, VOIT & MAYER, LTD., (SEATTLE OFFICE), TWO PRUDENTIAL PLAZA, SUITE 4900, CHICAGO, IL, 60601-6780, US

(73) Assignee: Sunbean Products, Inc., Boca Raton, FL

(21) Appl. No.: 10/215,414

(22) Filed: Aug. 7, 2002

(51) Int. Cl. H05B 1/02; H05B 3/02

(52) U.S. Cl. 219/486; 219/212

(57) ABSTRACT

A warming fabric that utilizes a multiplex circuit to provide heat to at least two different zones of the warming fabric. A controller for the warming fabric may alternate power supplied to the separate zones during a duty cycle. For example, the controller may supply power to a first zone of the warming fabric for a specified time based upon the heat setting for the first zone. During this specified time period, a second zone would not be supplied power. When the on time for the first zone is finished, the controller may apply power to the second zone for a specified time. If desired, separate zones may operate at different lengths of time during the duty cycle so that the separate zones would be supplied different levels of heating.

### FIELD OF THE INVENTION

The present invention relates generally to fabrics, and more particularly to electric heating fabrics such as warming blankets.

### BACKGROUND OF THE INVENTION

In general, a warming fabric, also called an “electric blanket,” or an “electric heating blanket,” is a blanket or another fabric material having an insulated electric heating element. The heating element is typically provided as one or more metallic wires threaded in a serpentine pattern throughout the blanket or arranged as a collection of parallel wires. The shape and size of the metallic wires varies, and in some cases the wires can actually be small metallic threads.

A warming fabric is typically plugged into a power outlet so that power may be supplied to the heating element, causing the production of heat. In this manner, the warming fabric may be a warm, comfortable cover, and may be used to warm a bed or may be wrapped around an individual as a heated, comfortable throw blanket, for example.

Contemporary warming fabrics usually include a user control, such as a dial, that permits a user to set the amount of heat output of the blanket. This feature allows the consumer to set the blanket to a setting that offers the desired amount of heat for a particular temperature and in accordance with the comfort level of the individual.

As an example, a user control for a warming fabric may include settings 1 to 10, with 10 being the warmest setting, and 1 being the least warm. These settings represent a range of possible heat outputs for the warming fabric, and the user's selection determines the amount of power supplied to the electric heating element, and therefore the temperature of the blanket.

For contemporary warming blankets, the settings typically represent the amount of time (the “duty cycle”) that power is supplied to the electric heating element during a fixed time period, such as 90 seconds. For a setting of 10, the time that power is supplied to the heating elements during the time period is longer than a setting of 9, 9 is longer than 8, and so forth. As one example, at the setting 10, power may be supplied to the blanket for the entire time period. For a low setting, such as 1, the power may be supplied for only a small percentage of the time, e.g., 10% of the duty cycle (i.e., in the example above, 9 seconds). The remaining settings may increase the duty cycle linearly as the setting increases (e.g., 20% at 2, 30% at 3, and so forth).

Although present warming fabrics work well for their intended purpose, the warming fabrics operate at high wattages so that they may produce the heat necessary for the high settings. However, in practice, most users do not use the highest setting. As an example, typical warming blankets utilize 180 Watts of power from a 120 Volt AC power supply. This wattage and voltage are necessary to provide the warming fabric with the heat necessary to operate at the higher temperatures. The high voltage used for the warming fabric requires a number of safety features, such as insulation and protection circuitry, to avoid shock and to meet Underwriter Labs (UL) requirements. These safety features add expense to the warming fabric, and may also add to bulk to the heating elements of the warming fabric, which is typically undesirable.

### SUMMARY OF THE INVENTION

The present invention provides a warming fabric that utilizes a multiplex circuit to provide heat to at least two different zones of the warming fabric. The multiplex circuit allows the peak wattage of the warming fabric to be lower, but still provides sufficient warmth for most applications. For example, instead of having a single 180-Watt heater wire, the heating elements may be provided in two separate 90-Watt zones.

In accordance with one aspect of the present invention, a controller for the warming fabric may alternate power supplied to the separate zones during a duty cycle. For example, the controller may supply power to a first zone of the warming fabric for a specified time based upon the heat setting for the first zone. During this specified time period, a second zone would not be supplied power. When the on time for the first zone is finished, the controller may apply power to the second zone for a specified time. Depending upon the heat setting chosen, at some points during the duty cycle, either between or after power is supplied to the two zones, both zones may not be given power.

If desired, separate zones may operate at different lengths of time during the duty cycle so that the separate zones would be supplied different heating. For example, the zone by a foot of the blanket may be supplied power for a period of time that is longer than the time power is supplied to a zone by the head of the blanket. This feature allows a user to apply more heat to the feet and legs than to the torso of the body, if desired. User controls may be provided so that the settings for separate zones may be set by a user.

In accordance with another aspect of the present invention, insulating materials or other features may be incorporated in the warming fabric so that there is very little heat loss when power is cut to a zone. In this manner, the zone may be supplied power in an alternating fashion (e.g., twenty seconds on, twenty seconds off), with a user feeling little loss of heat during the cycle.

The multiplex circuit of the present invention permits a warming fabric may be used with lower wattage than prior warming fabrics. As such, the resistive wire that is used as the heating elements in the warming fabric may be smaller, making the resistive wires less noticeable in the fabric. In addition, the warming fabric may operate with a lower voltage, permitting less expensive electronics to be used in the circuitry. Moreover, the voltage may be lowered to such an extent that serious shock hazards are effectively eliminated and UL requirements do not have to be met.

The multiplex circuitry of the present invention permits a single circuit to operate multiple zones. This feature eliminates the costly need for duplication of circuitry when using more than one zone in a warming fabric.

Other advantages will become apparent from the following detailed description when taken in conjunction with the drawings, in which:

### BRIEF DESCRIPTION OF THE DRAWINGS

FIG. 1 is a circuit diagram generally representing a warming fabric made in accordance with one aspect of the present invention;

FIG. 2 is a circuit diagram showing an alternate embodiment of a warming fabric incorporating the present invention; and

FIG. 3 is a flow diagram generally representing steps for controlling heat cycles for the warming fabric of FIG. 1 or 2 in accordance with one aspect of the present invention.

### DETAILED DESCRIPTION

In the following description, various aspects of the present invention will be described. For purposes of explanation, specific configurations and details are set forth in order to provide a thorough understanding of the present invention. However, it will be apparent to one skilled in the art that the present invention may be practiced without the specific details. Furthermore, well-known features may be omitted or simplified in order to not obscure the present invention.

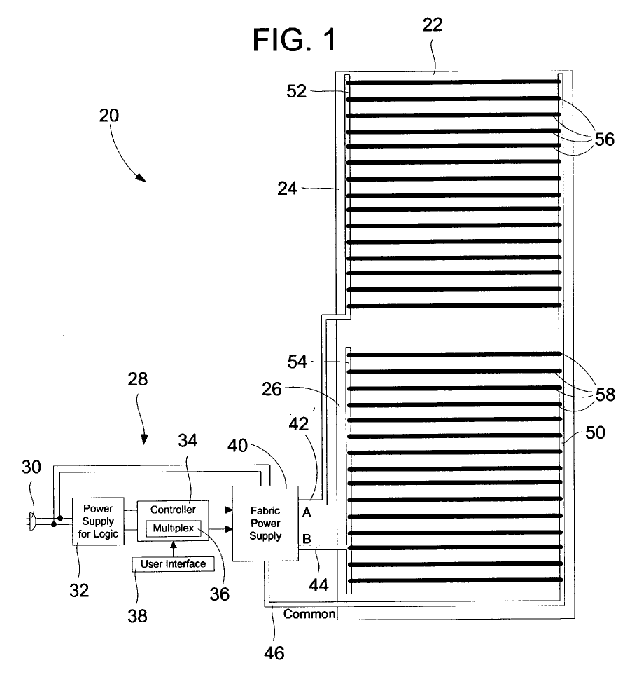

Referring now to the drawings, in which like reference numerals represent like parts throughout the several views, FIG. 1 shows a warming fabric 20 incorporating the present invention. The warming fabric 20 includes a blanket 22, made of a natural or synthetic material, such as a polyester/acrylic blend, or another suitable fabric or blend of material. Although a blanket 22 is described with respect to the embodiment shown, the features of the present invention may be used with a throw or mattress pad, or any other type of fabric that is to be heated.

A pair of electric heating elements 24, 26 is included in the blanket 22, the construction and operation of which are known in the art. In general, a heating element is any device or structure that may produce heat using electrical power. For example, the heating elements 24, 26 may be formed of resistive wires. A reference DC voltage is applied across the resistive wires to cause them to increase in temperature.

As an example, the resistive wires may be extruded from positive temperature coefficient (PTC) material, such as a conductive, plastic, PTC compound. PTC resistive wires are known in the art, and many different formulations of PTC may be used in their construction, or resistive wires made of other materials may be used.

The warming fabric 20 includes controls 28 connected to the electric heating elements 24, 26. A plug 30 or similar structure may be used for connecting the controls 28 to a power source (not shown). The power source may be, for example, a wall outlet, a DC power source such as batteries, or other sources of DC power.

A power supply 32 is connected between the plug 30 and a controller 34 for the warming fabric 20. If necessary, the power supply 32 may include an AC/DC converter, but in any event, typically provides a DC current to the controller 34. The controller 34 includes a multiplex module 36. The multiplex module 36 is described herein as a separate component of the controller 34 to aid in the description of its functions. However, a person of skill in the art may combine the functions of the multiplex module 36 with other functions of the controller 34, or may distribute those functions over multiple components. As used herein, however, a controller 34 having features of the multiplex module 36, whether provided as a separate module or component or integrated into the controller, is referred to as a “multiplex controller.”

A user interface 38 is connected to the controller 34. The user interface 38 may include one or more user controls and may be attached to the controller 34 via wires or a wireless connection. The user interface 38 may be mounted on the outside of a box for the controller 34, for example, and may be any type of configuration that permits a user or users to input a desired setting or settings for the warming fabric 20, e.g., dials, slide bars, push-button indexing units with digital or LED displays, and so forth. If desired, as further described below, separate user controls may be provided in the user interface 38 for the two electric heating elements 24, 26. Alternatively, a single user control may be used for controlling both heating elements 24, 26. Various other combinations may be configured by a person of skill in the art.

A power supply 40 for the warming fabric 20 is connected to the heating elements 24, 26. The power supply 40 supplies power (typically DC) to first and second leads 42, 44 for the heating elements 24, 26, respectively. A common ground 46 also leads from the power supply 40.

Briefly described, the power supply 40 supplies an appropriate amount of power to the electric heating elements 24, 26, based upon direction from the controller 34. The multiplex module 36 selectively energizes the electric heating elements 24, 26. The multiplex module 36 may, for example, set the amount of power that is selectively switched to the heating elements 24, 26 based at least in part upon one or two users' input via the user interface 38.

The controller 34 may be a standard control (i.e., a device or mechanism used to regulate or guide the operation of a machine, apparatus, or system), a microcomputer, or any other device that can execute computer-executable instructions, such as program modules. Generally, program modules include routines, programs, objects, components, data structures and the like that perform particular tasks or implement particular abstract data types. A programmer of ordinary skill in the art can program or configure the controller 34 (and the multiplex module 36 of the controller 34) to perform the functions described herein.

The multiplex module 36 is configured such that it may individually and selectively energize more than one heating element (e.g., the heating elements 24, 26). By selectively dividing power to multiple heating elements, a single controller 34 may be used to control multiple zones within a warming fabric. Moreover, lower wattage for the fabric may be used, because power is supplied to different zones at different times, and thus the power may be maximized while turned on in each zone.

The heating elements 24, 26 may be arranged in many different ways across the blanket 22. In one example shown in FIG. 1, a common bus 50 extends along one edge of the blanket 22. A first bus 52 is arranged at one end of the blanket 22 and extends along one edge of the blanket 22. The first bus 52 is connected to the first lead 42 from the power supply 40. A second bus 54 is located at the opposite end of the blanket 22 and is connected to the second lead 44 from the power supply 40. A first set of resistive wires 56 extends between the first bus 52 and the common bus 50. A second set of resistive wires 58 extends between the second bus 54 and the common bus 50.

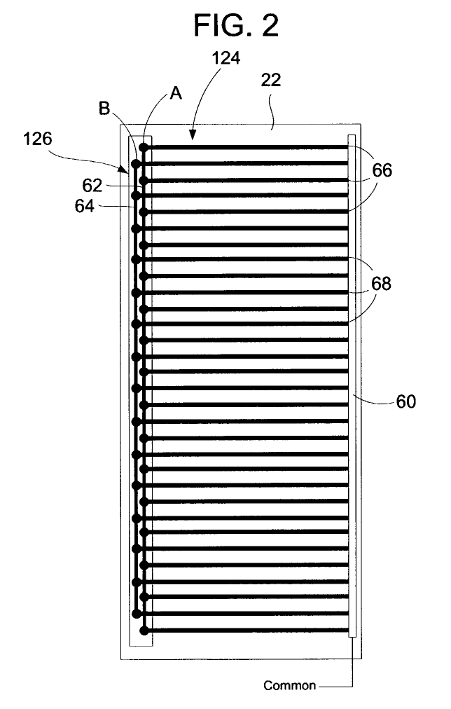

An alternate embodiment showing a different arrangement of electric heating elements 124, 126 is shown in FIG. 2. In the embodiment shown in FIG. 2, both of the electric heating elements 124, 126 extend the length of the blanket 122, covering the blanket 122 from a head portion to a foot portion. A common bus 60 extends along one edge of the blanket 122, and first and second busses 62, 64 for the first and second electric heating elements 124, 126 extend along the other side. Alternating resistive wires 66, 68 for the two electric heating elements 124, 126, respectively, extend between the first bus 62 and the common bus 60 (i.e., the resistive wires 66) and the second bus 64 and the common bus 60 (i.e., the resistive wires 68).

In addition to the structures shown in FIGS. 1 and 2, the electric heating elements 24, 26 may be arranged in a number of different ways relative to the blanket 22. For example, one heating element may be arranged so that it heats a first zone of the blanket 22 and another heating element may be arranged so that it heats another zone of the blanket 22. For the embodiment shown in FIG. 1, the heating element 24 may be located near a foot portion of the blanket 22, and thereby may heat the legs and feet of a user. The heating element 26, on the other hand, may be located at the opposite end of the blanket 22, and may be arranged to heat a user's torso. Alternatively, the two heating zones may be arranged so that they are located on opposite sides of the blanket 22, so that separate users may utilize different heat settings. Moreover, in addition to the two heating element embodiments that are described, three or more heating elements may be used in a warming fabric 20 formed in accordance with the aspects of the present invention.

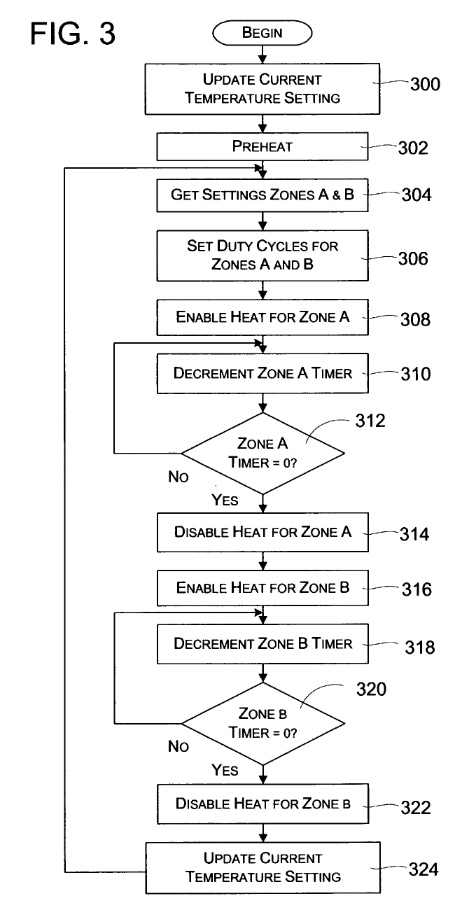

FIG. 3 shows steps for controlling power supplied to, and therefore heat transmitted by, the two different heating elements 24, 26 in accordance with one aspect of the present invention. In the steps, the two heating elements are referred to as “zones.” As used herein, a “zone” refers to the area that a heating element 24 (or 26) heats, which, as described above, may be one of various different locations on the blanket 22. The methods described with reference to the flow chart in FIG. 3 may be performed by the controller 34 using computer-executable instructions or other control logic. Describing the methods by reference to the flow chart aids one skilled in the art to develop programs including such instructions on a suitable controller 34.

The process in FIG. 3 begins by a user turning on the warming fabric 20, for example by toggling an “On” switch on the user interface 38, or by moving a temperature control from an “Off” position to a selected setting (e.g., 1 to 10). This results in updating the current setting (step 300).

At step 302, the warming fabric 20 goes through a pre-heat cycle which may, for example, be supplying full power alternatingly to the electric heating elements 24, 26 over a selected period of time, such as 30 minutes. While the warming cycle is not necessary for the present invention, warming cycles are typically used in warming fabrics to preheat heating elements prior to controlling their heat outputs.

At step 304, the controller 34 gets the settings for zones A and B. This current setting may be the user-set setting entered via the user interface 38, or may be a setting that is determined by one of many other factors, such as the room temperature, or may be a combination of two or more factors.

Based upon the settings retrieved in step 304, the controller 34 sets the heating cycles for zones A and B at step 306. The heating cycles may be set in one of many different ways, but in one example, the heating cycle is representative of the length of time that power is supplied to a heating element during a duty cycle. As another example, the heating cycle may be determined on a percentage of time available for the particular user. For example, if there are two heating elements (e.g., the heating elements 24, 26), then each of those heating elements may be allocated one half of the total duty cycle for the warming fabric 20. If the first heating element is set to maximum power, then it will be on during its entire portion of the duty cycle. If, however, the first heating element is set at half power (e.g., the setting “5” on a scale from 0 to 10) then that duty cycle would be half of the allotted amount of the duty cycle for that heating cycle, or one half of one half (i.e., one fourth). Alternatively, the zone may use more than one half the available time. In addition, if more than two zones are used, the zones may divide the duty cycle evenly or unevenly, as desired. The multiplex module 36 may be programmed so as to appropriately divide time between zones.

In any event, at step 308, the heat for zone A is turned on (i.e., power is supplied to the heat element for zone A). This is the beginning of A's heating cycle. The timer for zone A is decremented in step 310, and the timer is evaluated in step 312 to determine whether the heating time for zone A has elapsed. If the time has not elapsed, then the process loops back to step 310 where the timer is decremented again. This process continues until the allotted time has expired for zone A, and the process branches from step 312 to step 314, where the heat for zone A is turned off (i.e., power is cut to the heating element for zone A).

After the heating cycle for zone A is completed, then the heating cycle for zone B begins. A time interval may elapse between the duty cycles of zones A and B. At step 316, the heat for zone B is turned on, and at step 318, the timer for zone B is decremented. If the time has not expired for zone B, then step 320 loops back to step 318 where the timer is decremented again. This process continues until the time for zone B expires, where step 320 branches to step 322, and heat for zone B is turned off.

At step 324, the current temperature setting is checked again and the process loops back to step 304, where the next duty cycle begins. Again, a time interval may elapse before beginning the next duty cycle.

The heating cycles described with reference to FIG. 3 may be any period of time, for example as short as 1 to 5 seconds or as long as 1 to 2 minutes. The duty cycle is preferably sufficiently short so that a user cannot feel the cycling of power to a heating element in a zone. That is, the user preferably does not feel that power is alternatingly on and off to a heating element in a zone.

The steps in FIG. 3 may be performed by the multiplex module 36 of the controller 34, or may be otherwise performed by the controller 34. As can be understood, because zones A and B are considered separately in the steps of FIG. 3, the heat settings for the two zones may be different. For example, a user may set two different heat settings via the user interface 38 for the heat zones A and B. In this manner, different levels of heat may be supplied to different zones of the blanket 22.

The warming fabric 20 of the present invention, because it uses the multiplex controls 28, provides many advantages over prior art warming fabrics. For example, the duration of a duty cycle in which no power is supplied to heating elements may be very short. Cycling between the duty cycles of zones A and B may occur quickly, so that a user does not feel the loss of power to the zones during cycling. To aid in this effect, the resistive wires may be encapsulated in insulation, may include PTC material (which tends to maintain a constant temperature when power is cycled through it), or may otherwise be protected or configured to avoid heat loss. As such, the wattage of a blanket may be reduced, and, instead of having a single high wattage heating element (e.g., 180 Watts), the warming fabric may be split into two or more 90-Watt zones. Although such a blanket could not operate at as high a heat as a warming fabric drawing 180 Watts of power, the warming fabric 20 of the present invention can provide sufficient heat for most applications.

Because lower wattage may be used for the warming fabric 20, less current or lower voltage may be used. This feature permits less expensive electronics in the controller 34, such as smaller and less expensive triacs, and also permits safer voltages to be used for warming fabrics, which may assuage the concerns that some users have about sleeping under or otherwise using a high voltage product. In addition, using lower current permits the resistive wires to be reduced in cross-sectional area, because less current has to be carried through the wires. This feature permits the wires to be thinner and more flexible, and thus less noticeable in the blanket 22.

In addition to the above benefits, the warming fabric 20 provides heating in separate zones, which permits a user to selectively heat one zone more than another. This feature is provided with one set of controls, wherein prior art warming blankets having more than one zone typically utilize a separate control for each zone of the blanket.

Other variations are within the spirit of the present invention. Thus, while the invention is susceptible to various modifications and alternative constructions, a certain illustrated embodiment thereof is shown in the drawings and has been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

What is claimed is:

1. A warming fabric, comprising:
a fabric;
a first heating element aligned along the fabric and configured to heat a first zone of the fabric;
a second heating element aligned along the fabric and configured to heat a second zone of the fabric; and
a multiplex controller for cycling power individually and alternatively between the first heating element and the second heating element.

2. The warming fabric of claim 1, wherein the multiplex controller is configured to provide more power to the first heating element than the second heating element.

3. The warming fabric of claim 2, wherein the multiplex controller provides more power to the first heating element by cycling power to the first heating element longer than the second heating element.

4. The warming fabric of claim 2, wherein the first zone is collocated with the second zone.

5. The warming fabric of claim 4, wherein the first heating element and the second heating element share a common bus that extends along one edge of the warming fabric.

6. The warming fabric of claim 2, wherein the first zone is separated from the second zone.

7. The warming fabric of claim 6, wherein the fabric is a blanket, and wherein the first zone is configured to align adjacent the legs of a user, and the second zone is configured to align with a torso of a user.

8. The warming fabric of claim 1, wherein the first heating element and the second heating element share a common bus that extends along one edge of the warming fabric.

9. The warming fabric of claim 1, wherein the first zone is separated from the second zone.

10. The warming fabric of claim 9, wherein the fabric is a blanket, and wherein the first zone is configured to align adjacent the legs of a user, and the second zone is configured to align with a torso of a user.

11. The warming fabric of claim 1, wherein the warming fabric comprises a single multiplex controller.

12. The warming fabric of claim 1, wherein the multiplex controller is configured to provide selective cycle power by defining a duty cycle and providing power to the first heating element during a first portion of the duty cycle, and providing power to the second heating element during a second portion of the cycle.

13. The warming fabric of claim 12, wherein the multiplex controller is further configured to cut power to both heating elements during a third portion of the duty cycle.

14. The warming fabric of claim 1, further comprising a third heating element along the fabric that is individually and selectively energized by the multiplex controller.

15. A warming fabric, comprising:
a fabric;
a first heating element aligned along the fabric and configured to heat a first zone of the fabric;
a second heating element aligned along the fabric and configured to heat a second zone of the fabric; and
one and only one multiplex controller for cycling power individually and alternatively between the first heating element and the second heating element.
